(19) United States
(12) Patent Application Publication
(10) Pub. No.: US 2007/0177493 A1
(43) Pub. Date: Aug. 2, 2007

(54) Carrier recovery circuit and method

(75) Inventors: Chia-Hsin Lin, Taipei (TW); Po-Chun Huang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies Inc.

(21) Appl. No.: 11/341,823

(22) Filed: Jan. 27, 2006

(51) Int. Cl. H04J 11/00

(52) U.S. Cl. 370/208

(57) ABSTRACT

A carrier recovery circuit of receiving an OFDM data, comprising a demodulator, a domain transformer, an equalizer, a frequency offset detector, and a compensator. The demodulator demodulates the OFDM data with a carrier signal. The domain transformer is coupled to the demodulator, and transforms the OFDM data to frequency domain. The equalizer is coupled to the domain transformer and frequency equalizes the OFDM data. The frequency offset detector is coupled to the equalizer, retrieves a phase reference data from the OFDM data, and determines a frequency offset based on the phase reference data and a predetermined data in the carrier recovery circuit. The compensator is coupled to the frequency offset detector, and compensates the frequency offset signal based on the estimated frequency offset.

### BACKGROUND OF THE INVENTION

1. Field of the Invention

The present invention relates to Orthogonal Frequency Division Multiplexing (OFDM), and in particular relates to carrier recovery circuit and method in OFDM system.

2. Description of the Related Art

Carrier recovery synchronizes carrier frequency between a transmitter and a receiver by estimating carrier frequency offset therebetween.

Orthogonal Frequency Division Multiplexing (OFDM) has gained considerable interest in recent years. As each subchannel is packed closely in OFDM system, accurate carrier demodulation is critical to retrieve data.

In OFDM system, a transmitter modulates data on frequency domain subchannels, with each corresponding to a subcarrier, then mixes the data by a carrier signal with carrier frequency fet, and transforms which to time domain signal for transmission over radio channels to a receiver. The receiver demodulates the data by local carrier signal Scr with carrier frequency fcr, so that the original data may be recovered. If receiver carrier signal Scr is different from the transmitter carrier signal Set, the correct data cannot be retrieved in the receiver, leading to the necessity of a carrier recovery scheme to synchronize carrier signals thereof.

Conventionally the carrier frequency offset is estimated by two pre-specified OFDM symbols, known as “pilot symbols” or “training sequences”, with the second symbol equal to the first one shifted by a phase difference exp[j2π(Δf*T)], where Δf is the carrier frequency offset (fcr-fct) between the transmitter and the receiver, and T is the sampling duration of an OFDM frame.

The pilot symbols are added to each, OFDM frame in the transmitter and retrieved in the receiver, such that pilot symbols from two consecutive OFDM frames are compared to generate carrier frequency offset Δf for carrier recovery. FIG. 1 shows a constellation diagram of corresponding pilot symbols from two consecutive OFDM frames, comprising symbols 100a, b, c, d from a first OFDM frame, and symbols 102a, b, c, d from a second OFDM frame. The angular difference Δθ between symbols 100a, b, c, d and 102a, b, c, d respectively is determined to deduce carrier frequency offset Δf by:
Δf=Δθ/(2π*T) (EQU1)

FIG. 2(a) and (b) are block diagrams of conventional receivers with carrier recovery capability.

Referring to FIG. 2(a), showing a conventional receiver comprising delay element 200, demodulators 202a and 202b, domain transformers 204a and 204b, phase difference detector 206, filter 208, oscillator 210, and equalizer 212. Upon initialization, receiver 2a receives and keeps previous data Dₗ₋₁ in delay element 200 while receiving current data Dₗ, then demodulates previous data Dₗ₋₁ and current data Dₗ in demodulators 202a and 202b respectively with carrier signal Scr, converts data Dₗ₋₁ and Dₗ to frequency domain via domain transformers 204a and 204b, frequency equalizes data Dₗ₋₁ and Dₗ in equalizer 212, obtains corresponding pilot symbols from previous data Dₗ₋₁ and current data Dₗ and determines frequency offset therebetween in phase difference detector 206, filters out undesirable components from phase difference detector 206 to output frequency offset Δf by filter 208, compensates frequency offset Δf in oscillator 210, subsequently demodulates data Dₗ and next data Dₗ₊₁ with correction signal −Δf.

Referring to FIG. 2(b), showing another conventional receiver comprising demodulator 220, domain transformers 222, buffer 224, phase difference detector 226, filter 228, oscillator 230, and equalizer 232. Receiver 2b receives, demodulates, transforms and keeps previous data Dₗ₋₁ in buffer 224, then receives and demodulates current data Dₗ, transforms current data Dₗ to frequency domain in domain transformer 222, stores data Dₗ in buffer 224 where data Dₗ₋₁ is kept previously, frequency equalizes data Dₗ in equalizer 232, obtains corresponding pilot symbols from previous data Dₗ₋₁ and current data Dₗ and determines frequency offset therebetween in phase difference detector 226, filters out undesirable components from phase difference detector 226 to output frequency offset Δf by filter 228, compensates frequency offset Δf in oscillator 230, subsequently demodulates data Dₗ and next data Dₗ₊₁ with correction signal −Δf.

Since receiver 2a and 2b employ pilot symbols from two consecutive data Dₗ₋₁ and Dₗ to compute frequency offset Δf, data latency of two data and circuit complexity is expected. It is desirable to reduce computation latency of frequency offset Δf and simplify receiver circuit design. Therefore a method and circuit of carrier recovery is proposed in the invention.

### BRIEF SUMMARY OF INVENTION

A detailed description is given in the following embodiments with reference to the accompanying drawings.

According to one embodiment of the invention, a carrier recovery circuit of receiving an OFDM data is described, comprising a demodulator, a domain transformer, an equalizer, a frequency offset detector, and a compensator. The demodulator demodulates the OFDM data with a carrier signal. The domain transformer is coupled to the demodulator, and transforms the OFDM data to frequency domain. The equalizer is coupled to the domain transformer and frequency equalizes the OFDM data. The frequency offset detector is coupled to the equalizer, retrieves a phase reference data from the OFDM data, and determines a frequency offset based on the phase reference data and predetermined data Dpre in the carrier recovery circuit. The compensator is coupoed to the frequency offset detector, and compensates the carrier signal based on the frequency offset.

According to another embodiment of the invention, a carrier recovery circuit comprises a symbol generator generating a phase reference data from an input data by a carrier signal, a frequency offset detector coupled to the symbol generator, determining a frequency offset based on the phase reference data and a predetermined data in the carrier recovery circuit, and a compensator coupled to the frequency offset detector, compensating the carrier signal based on the frequency offset.

According to another embodiment of the invention, a method of carrier recovery in a receiver comprises generating a phase reference data from an input data by a carrier signal, determining a frequency offset based only on the phase reference data and a predetermined data in the receiver; and compensating the carrier signal based on the frequency offset.

### BRIEF DESCRIPTION OF DRAWINGS

The present invention can be more fully understood by reading the subsequent detailed description and examples with references made to the accompanying drawings, wherein:

FIG. 1 shows a constellation diagram of corresponding pilot symbols from consecutive OFDM frames.

FIG. 2(a) and (b) are block diagrams of conventional receivers with carrier recovery capability.

FIG. 3 is a block diagram of an exemplary carrier recovery circuit in the invention.

FIG. 4 is a detailed block diagram of an exemplary carrier recovery circuit in FIG. 3.

FIG. 5 is a flowchart of an exemplary carrier recovery method in the invention, incorporating the carrier recovery circuit in FIG. 4.

FIG. 6 is a constellation diagram of phase reference data incorporating carrier recovery method 50 in FIG. 5.

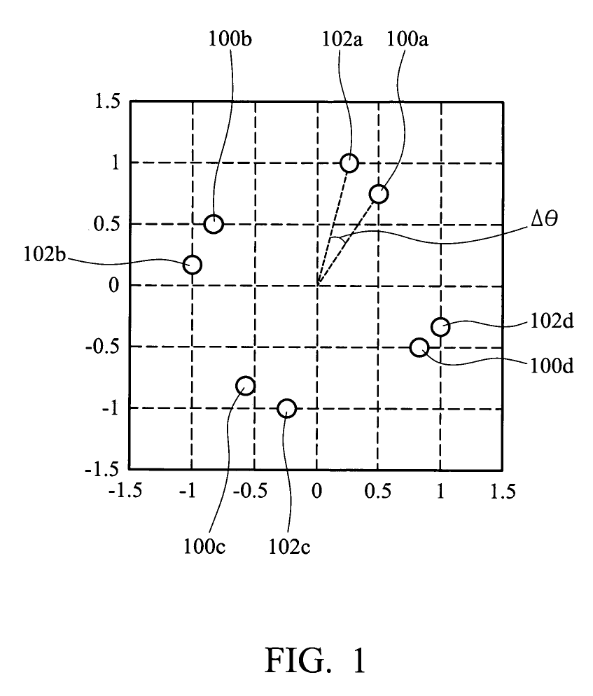

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

For simplicity, while this disclosure of the invention is incorporated into an OFDM system, the circuitry and method disclosed may also find application in other systems, and those skilled in the art may make modifications where appropriate based on the principle of the invention.

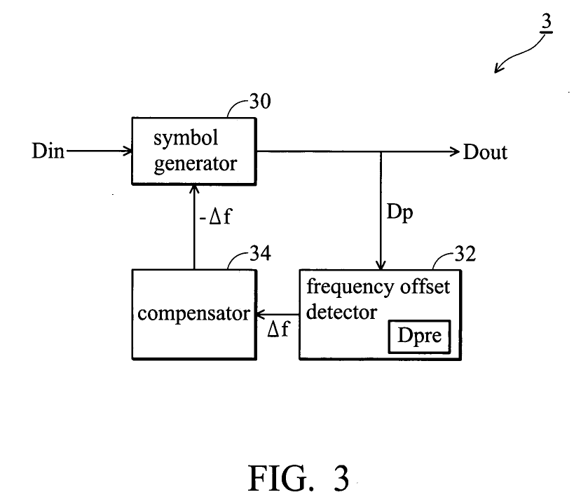

FIG. 3 is a block diagram of an exemplary carrier recovery circuit in the invention, comprising symbol generator 30, frequency offset detector 32, and compensator 34. Symbol generator 30 is coupled to frequency offset detector 32, compensator 34, subsequently to symbol generator 30. Carrier recovery circuit 3 may be incorporated into a receiver to obtain carrier frequency synchronization between a corresponding transmitter and the receiver.

Symbol generator 30 receives input data Din from the transmitter, performs carrier demodulation to input data Din by correction signal −Δf to generate phase reference data Dp. Phase reference data Dp is a pre-specified symbol known by both the transmitter and the receiver, inserted in input data Din prior to transmission, and may be a pilot symbol. Input data Din may be an OFDM data, an FDM data, or any signal with a phase reference data, and modulated with transmitter carrier frequency fct at the transmitter. Transmitter carrier frequency fct at the transmitter may be different from receiver carrier frequency Scr at the receiver, thus the necessity

Frequency offset detector 32 accepts phase reference data Dp from symbol generator 30 to determine frequency offset Δf based on phase reference data Dp and a predetermined data. Frequency offset Δf is difference between receiver carrier frequency Scr at the receiver and transmitter carrier frequency fct at the transmitter. Predetermined data Dpre is the pre-specified symbol agreed by the transmitter and the receiver, and is estimated or stored in the receiver. Predetermined data Dpre may be pilot symbols or any other suitable reference.

Compensator 34 receives frequency offset Δf from frequency offset detector 32 to compensate frequency offset to synchronize with transmitter carrier signal fct and receiver carrier Scr.

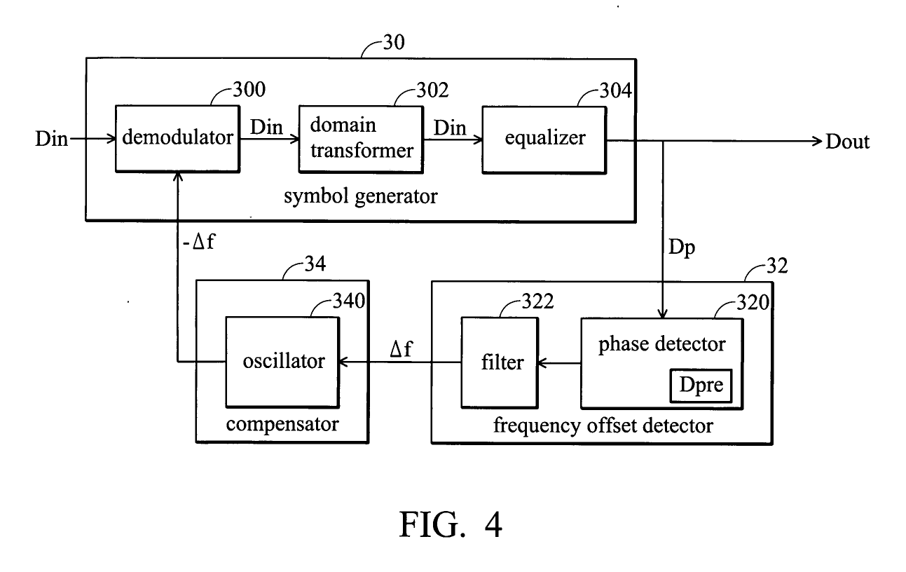

FIG. 4 is a detailed block diagram of an exemplary carrier recovery circuit in FIG. 3, in which symbol generator 30 comprises demodulator 300, domain transformer 302, equalizer 304, frequency offset detector 32 comprises phase detector 320, filter 322, and compensator 34 comprises oscillator 340. Demodulator 300 is coupled to domain transformer 302, equalizer 304, phase detector 320, filter 322, oscillator 340, then to demodulator 300.

Demodulator 300 performs carrier demodulation to input data Din by correction signal −Δf, then domain transformer 302 transforms input data Din from time domain to frequency domain, and equalizer 304 frequency equalizing input data Din to remove channel selective fading effect. Demodulator 300 may be a multiplier multiplying input data Din by receiver carrier signal Scr. Domain transformer 302 employs Discrete Fourier Transform algorithm for the time to frequency domain transformation, and may be realized by Fast Fourier Transform. Input data Din comprises data symbols and phase reference data Dp.

Phase detector 320 receives phase reference data Dp, estimates phase difference Δθ between phase reference data Dp and predetermined data Dpre, and produces frequency offset Δf based on the phase difference Δθ and the following equation:
Δf=Δθ/(2π*N) (EQU2)
where Δf is, Δf is, and N is sampling number of a OFDM frame

Filter 322 then filters out undesirable components and outputs frequency offset Δf.

Oscillator 340 obtains frequency offset Δf from filter 322, adjusts and generates correction signal −Δf according to frequency offset Δf, such that input data Din is synchronized between transmitter and receiver. Oscillator 340 may be a numerically controlled oscillator (NCO) or a voltage controlled oscillator (VCO).

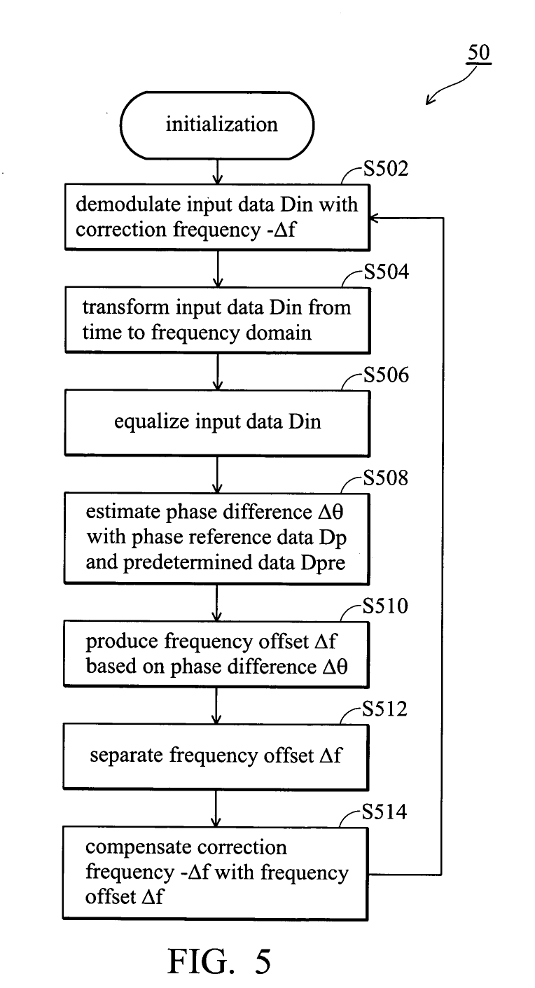

FIG. 5 is a flowchart of an exemplary carrier recovery method in the invention, incorporating the carrier recovery circuit in FIG. 4.

Upon initialization, in step S502 demodulator 300 receives input data Din and demodulates.

In step S504, domain transformer 302 transforms input data Din from time to frequency domain to recover input data Din in the baseband spectrum, thereby retrieving phase reference data Dp from corresponding phase reference subcarrier. The frequency domain transformation is implemented by Discrete Fourier Transform, and may be realized by Fast Fourier Transform.

Next in step S506, equalizer 304 frequency equalizing input data Din to remove frequency selective fading effect, so that phase reference data Dp is comparable with predetermined data Dpre in receiver 3.

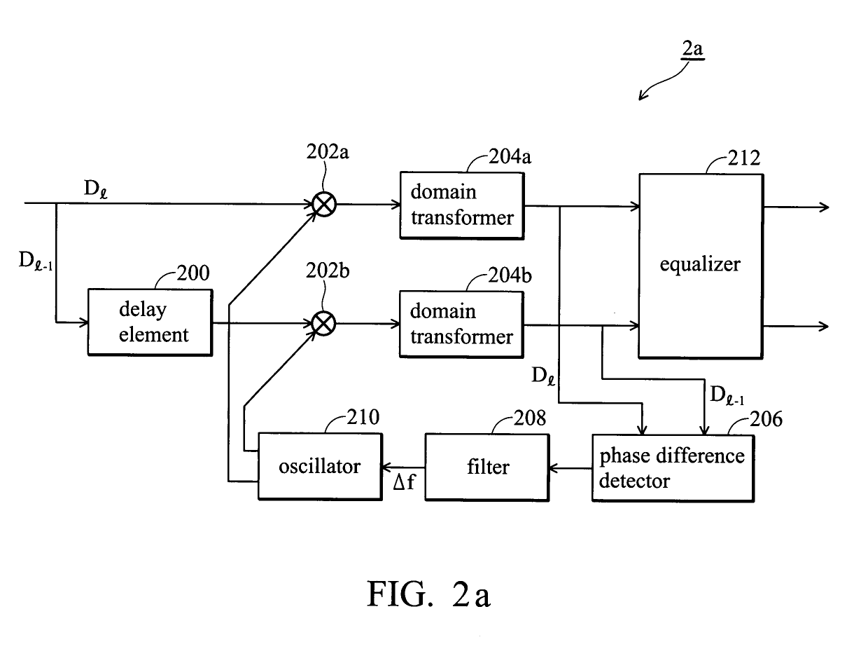

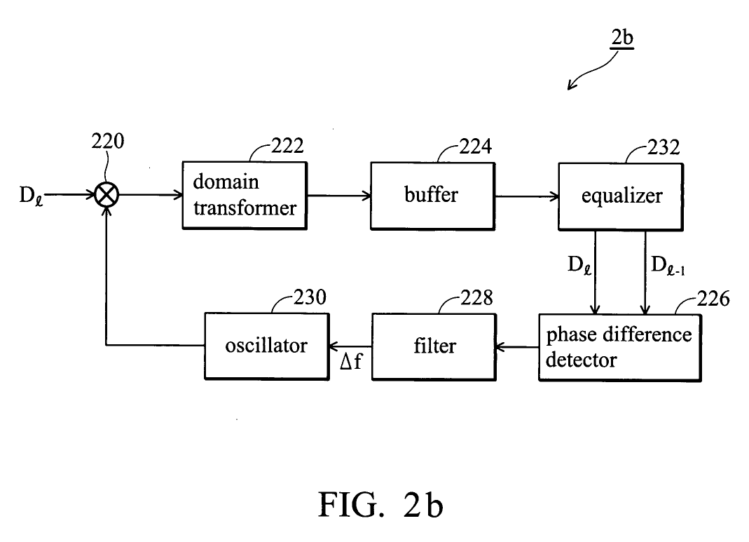

In step S508, phase detector 320 obtains phase reference data Dp, and estimates phase difference Δθ between the phase referencce data Dp and predetermined data Dpre Phase detector 320 determines frequency offset Δf with-only phaseTeference data Dp from a single OFDM frame and predetermined data Dpre in receiver 3, reducing computation latency of frequency offset Δf in comparison to receivers 2a and 2b in FIG. 2.

Subsequently instep S510, phase detector 320 produces the frequency offset Δf with the phase difference Δθ by EQU2.

In step S512, filter 322 filters out undesirable components from the output of phase detector 320, thereby producing frequency offset Δθ to oscillator 340.

In step S514, oscillators compensates correction signal −Δf with frequency offset Δf, thereby removing offset frequency Δf.

Carrier recovery method 50 then returns to step S502 to demodulate input data Din with the correction signal −Δf and undergoes steps S502, S504, S506, S508, S510, S512, and S514 repeatedly until completion of the method.

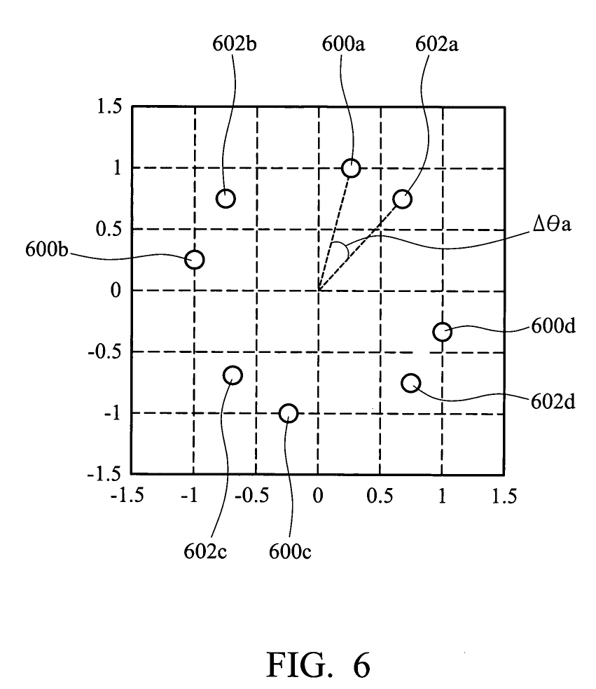

FIG. 6 is a constellation diagram of phase reference data incorporating carrier recovery method 50 in FIG. 5, comprising phase reference data 600a, b, c, d, and predetermined data 602a, b, c, d.

Upon initialization of carrier recovery method 50, data Din is demodulated with correction signal −Δf in step S502, transformed to frequency domain in step S504, frequency equalized in step S506, phase reference data Dp is then retrieved from data Din as one of reference symbols 600a, b, c, d. In the case of 600a as phase reference data Dp, phase difference Δθ is estimated as angular difference Δθa between phase reference data 600a and predetermined data 602a in step S510, frequency offset Δfa is produced by EQU2 in step S512, frequency offset Δf is compensated by taking off the estimated frequency offset Δfa from carrier frequency in step S514, and next input data Din is subsequently demodulated by compensated frequency offset Δf in S502.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A carrier recovery circuit of receiving an Orthogonal Frequency Division Multiplexing (OFDM) data, comprising:
a demodulator demodulating the OFDM data with a carrier signal;
a domain transformer coupled to the demodulator, transforming the demodulated OFDM data to frequency domain;
an equalizer coupled to the domain transformer, frequency equalizing the transformed OFDM data;
a frequency offset detector coupled to the equalizer, retrieving a phase reference data from the equalized OFDM data, determining a frequency offset based on the phase reference data and a predetermined data in the carrier recovery circuit; and
a compensator coupled to the frequency offset detector, compensating the carrier signal based on the frequency offset.

2. The carrier recovery circuit of claim 1, wherein the phase reference data is a pilot symbol.

3. The carrier recovery circuit of claim 1, wherein the frequency offset detector comprises:
a phase detector coupled to the symbol generator, estimating a phase difference Δθ between the phase reference data and the predetermined data; and
a frequency offset module coupled to the phase detector producing the frequency offset Δf based on the phase difference.

4. The carrier recovery circuit of claim 1, wherein the demodulator is a multiplier, multiplying the input data by the carrier signal.

5. The carrier recovery circuit of claim 1, wherein the domain transformer transforming the input data frequency domain by Discrete Fourier Transform.

6. The carrier recovery circuit of claim 3, wherein the frequency offset is:
Δf=Δθ/(2πN)
where Δf is the frequency offset, Δθ is the phase difference, and N is sampling number of the OFDM data.

7. A carrier recovery circuit, comprising:
a symbol generator generating a phase reference data from an input data by a carrier signal;
a frequency offset detector coupled to the symbol generator, determining a frequency offset based on the phase reference data and a predetermined data in the carrier recovery circuit; and
a compensator coupled to the frequency offset detector, compensating the carrier signal based on the frequency offset.

8. The carrier recovery circuit of claim 7, wherein the phase reference data is a pilot symbol.

9. The carrier recovery circuit of claim 7, wherein the input data is an OFDM data.

10. The carrier recovery circuit of claim 7, wherein the frequency offset detector comprises:
a phase detector coupled to the symbol generator, estimating a phase difference Δθ between the phase reference data and the predetermined data; and
a frequency offset module coupled to the phase detector producing the frequency offset Δf based on the phase difference.

11. The carrier recovery circuit of claim 10, wherein the frequency offset is:
Δf=Δθ/(2πN)
where Δf is the frequency offset, Δθ is the phase difference, and N is sampling number of the OFDM data.

12. The carrier recovery circuit of claim 7, wherein the compensator comprises an oscillator coupled to the frequency offset detector and the symbol generator, adjusting the carrier signal with the offset frequency.

13. The carrier recovery circuit of claim 7, wherein the symbol generator comprises:
a demodulator, demodulating the input data in time domain with the carrier signal; and
a domain transformer transforming the input data from time domain to frequency domain by Discrete Fourier Transform.

14. The carrier recovery circuit of claim 12, wherein the symbol generator further comprises an equalizer coupled to the domain transformer, equalizing the input data.

15. A method of carrier recovery in a receiver, comprising:
generating a phase reference data from an input data by a carrier signal;
determining a frequency offset based only on the phase reference data and a predetermined data in the receiver; and
compensating the carrier signal based on the frequency offset.

16. The method of claim 15, wherein the phase reference data is a pilot symbol.

17. The method of claim 15, wherein the determining step comprises:
estimating a phase difference Δθ between the phase reference data and the predetermined data; and
producing the frequency offset Δf based on the phase difference.

18. The method of claim 17, wherein the frequency offset is:
Δf=Δθ/(2πN)
where Δf is the frequency offset, Δθ is the phase difference, and N is sampling number of the OFDM data.

19. The method of claim 15, wherein the compensating step comprises adjusting the carrier signal with the offset frequency.

20. The method of claim 15, wherein the generating step comprises:
demodulating the input data in time domain by the carrier signal; and
transforming the input data from time domain to frequency domain by Discrete Fourier Transform.

21. The method of claim 20, wherein the Discrete Fourier Transform is Fast Fourier Transform.

22. The method of claim 15, further comprising frequency equalizing the input data.

23. The method of claim 15, wherein the input data is an OFDM data.
